(19) United States
(12) Patent Application Publication
(10) Pub. No.: US 2025/0167257 A1
(43) Pub. Date: May 22, 2025

(54) ELECTROCHEMICAL CELL FLOW FIELDS

(71) Applicant: FuelCell Energy, Inc., Danbury, CT (US)

(72) Inventors: Benjamin POETTGEN, Danbury, CT (US); Jonathan MALWITZ, Danbury, CT (US); Chris HOWARD, Danbury, CT (US); Carl A. WILLMAN, Newtown, CT (US); Brian BULLECKS, Sumner, ME (US); Lawrence J. NOVACCO, Brookfield, CT (US)

(21) Appl. No.: 18/888,565

(22) Filed: Sep. 18, 2024

Related U.S. Application Data
(60) Provisional application No. 63/600,203, filed on Nov. 17, 2023.

(51) Int. Cl. H01M 8/0258; C25B 13/02; H01M 8/0254

(52) U.S. Cl. CPC H01M 8/0258; C25B 13/02; H01M 8/0254

(57) ABSTRACT

A flow field for supplying a reactant to an electrode of an electrochemical cell includes an inlet configured to receive the reactant from a reactant supply, an outlet configured to expel spent reactant, the outlet positioned on an opposite side of the flow field from the inlet, a first plate configured to contain the reactant between the first plate and the electrode across substantially an entire surface area of the electrode, and a separator plate configured to be positioned between the first plate and the electrode and to divide the reactant into a first portion and a second portion at the inlet, the separator plate having a smaller surface area than the first plate.

### CROSS-REFERENCE TO RELATED APPLICATIONS

This application claims the benefit of and priority to U.S. Provisional Patent Application No. 63/600,203, filed Nov. 17, 2023, which is incorporated by reference herein in its entirety.

### BACKGROUND

The present disclosure relates generally to the field of electrochemical cells. In particular, the present disclosure relates to gas flow field designs for fuel cells.

A fuel cell is a type of electrochemical cell that uses an electrochemical reaction to convert chemical energy stored in a fuel such as hydrogen or methane into electrical energy. In general, fuel cells typically include an anode and a cathode separated by an electrolyte contained in an electrolyte matrix. The anode, the cathode, and the electrolyte may be disposed between a first flow field and a second flow field, with the first flow field adjacent the anode and the second flow field adjacent the cathode. The flow field may act as a current collector and as a distributor of reactant gases. Fuel flows to the anode via the first flow field, and an oxidant flows to the cathode via the second flow field. The fuel cell may oxidize the fuel in an electrochemical reaction, which releases a flow of electrons between the anode and cathode, thereby converting chemical energy into electrical energy. Multiple fuel cells may be arranged in a stack with a cathode flow field, a bipolar plate, and an anode flow field between each fuel cell.

The efficiency of a fuel cell increases with the amount of fuel that is utilized within the fuel cell anode. The chemical reactions in the fuel cell are generally exothermic, driving up the temperature of the fuel cell. In a typical fuel cell, the reactions may concentrate near the reactant inlets of the anode and the cathode, resulting in hot spots in the fuel cell. Large temperature variations across the fuel cell can reduce the lifetime of the cell. Accordingly, a need exists for providing a more uniform reaction distribution in the fuel cell to achieve a more uniform temperature distribution to improve the life of the cell.

### SUMMARY

In one aspect, the present disclosure describes a flow field for supplying a reactant to an electrode of an electrochemical cell. The flow field includes an inlet configured to receive the reactant from a reactant supply, an outlet configured to expel spent reactant, the outlet positioned on an opposite side of the flow field from the inlet, a first plate configured to contain the reactant between the first plate and the electrode across substantially an entire surface area of the electrode, and a separator plate configured to be positioned between the first plate and the electrode and to divide the reactant into a first portion and a second portion at the inlet, the separator plate having a smaller surface area than the first plate.

In some embodiments, the separator plate is configured to separate the second portion of the reactant from a portion of the electrode. In some embodiments, the separator plate extends from the inlet to a first position between the inlet and the outlet. In some embodiments, the first position is between 30% and 70% of the distance from the inlet to the outlet, or between 40% and 60% of the distance from the inlet to the outlet, or between 45% and 55% of the distance from the inlet to the outlet, or at approximately half the distance between the inlet and the outlet. In some embodiments, the separator plate has substantially the same surface area as and spans substantially an entire footprint of the surface area of a portion of the first plate defined between the inlet and the first position. In some embodiments, between the first position and the outlet, the separator plate does not separate the first portion of the reactant from the second portion of the reactant.

In some embodiments, the flow field includes a second separator plate configured to divide the second portion of the reactant into a third portion of the reactant between the separator plate and the second separator plate and a fourth portion of the reactant between the second separator plate and the first plate. In some embodiments, the second separator plate extends to a second position, wherein the second position is closer than the first position to the outlet.

In some embodiments, the separator plate includes an opening configured to allow the first portion of the reactant to mix with the second portion of the reactant. In some embodiments, the separator plate includes a plurality of openings configured to allow the first portion of the reactant to mix with the second portion of the reactant. In some embodiments, a space between the closest opening to the inlet and the second closest opening to the inlet is larger than a space between the second closest opening to the inlet and the third closest opening to the inlet. In some embodiments, the space between adjacent openings decreases as the separator plate approaches the outlet.

In another aspect, the present disclosure describes an electrochemical cell assembly including an electrochemical cell including an electrode and a flow field assembly positioned adjacent the electrode. The flow field assembly includes a first plate spanning substantially an entire footprint of the electrode, a separator plate positioned between the first plate and the electrode and spanning less than the entire footprint of the electrode, the separator plate defining a first flow channel between the separator plate and the electrode and a second flow channel between the separator plate and the first plate, an inlet configured to receive reactant from a reactant supply and to supply the reactant to the first flow channel and the second flow channel, and an outlet configured to expel spent reactant, the outlet positioned on an opposite side of the first plate from the inlet.

In some embodiments, the separator plate has substantially the same surface area as and spans substantially an entire footprint of a portion of the electrode between the inlet and a first position along a flow direction. In some embodiments, the flow direction is defined as a prevailing direction of reactant flow from the inlet to the outlet. In some embodiments, the separator plate is configured to separate a portion of the reactant from the portion of the electrode between the inlet and the first position. In some embodiments, the first position is between 30% and 70% of the distance from the inlet to the outlet, or between 40% and 60% of the distance from the inlet to the outlet, or between 45% and 55% of the distance from the inlet to the outlet, or at approximately half the distance between the inlet and the outlet. In some embodiments, the second flow channel joins the first flow channel at the first position.

In some embodiments, the separator plate includes an opening configured to allow a first portion of reactant in the first flow channel to mix with a second portion of reactant in the second flow channel. In some embodiments, the separator plate includes a plurality of openings configured to allow a first portion of reactant in the first flow channel to mix with a second portion of reactant in the second flow channel. In some embodiments, a space between the closest opening to the inlet and the second closest opening to the inlet is larger than a space between the second closest opening to the inlet and the third closest opening to the inlet. In some embodiments, the space between adjacent openings decreases as the separator plate approaches the outlet.

In another aspect, the present disclosure describes a flow field for supplying a reactant to an electrode of an electrochemical cell. The flow field includes a sheet including a plurality of wave-shaped corrugations, the wave-shaped corrugations forming a first channel on a first side of the sheet, a second channel on the first side of the sheet, and a third channel between the first channel and the second channel on a second side of the sheet opposite the first side, a first opening in a first wall separating the first channel and the third channel, a second opening in a second wall separating the second channel and the third channel, and a blocking plate positioned across the third channel between the first opening and the second opening.

In some embodiments, the blocking plate is configured to fluidly isolate the first opening from the second opening when the sheet is positioned between a flat plate and the electrode. In some embodiments, when the sheet is positioned between a flat plate and the electrode and reactant is supplied to the channels, the sheet is configured (a) to allow reactant in the third channel to be exposed to the electrode and (b) to separate reactant in the first channel and the second channel from the electrode. In some embodiments, the first channel, the second channel, and the third channel each include an inlet and an outlet, wherein the first opening is closer than the blocking plate to the inlets, and the blocking plate is closer than the second opening to the inlets.

In some embodiments, the blocking plate is integrally formed with the second wall. In some embodiments, the flow field further includes a bend joining the blocking plate and the second wall, wherein the second opening is adjacent the bend and is substantially the same size and shape as the blocking plate. In some embodiments, the first channel and the second channel are two of a first plurality of channels on the first side of the sheet, and the third channel is one of a second plurality of channels on the second side of the sheet. In some embodiments, the first opening and the second opening are two of a first plurality of openings in walls between each channel of the first plurality of channels and an adjacent channel in the second plurality of channels, and the blocking plate is one of a plurality of blocking plates, each blocking plate positioned across one of the first or second pluralities of channels and between adjacent openings.

In another aspect, the present disclosure describes an electrochemical cell assembly including a flat plate, an electrochemical cell including an electrode, and a flow field positioned between the electrode and the plate. The flow field includes a sheet including a plurality of wave-shaped corrugations, the wave-shaped corrugations forming a first channel between the plate and the sheet, a second channel between the plate and the sheet, and a third channel between the first channel and the second channel and between the sheet and the electrode, a first opening in a first wall separating the first channel and the third channel, a second opening in a second wall separating the second channel and the third channel, and a blocking plate positioned across the third channel between the first opening and the second opening.

In some embodiments, the blocking plate is configured to fluidly isolate the first opening from the second opening. In some embodiments, the third channel is exposed to the electrode, and the sheet blocks the first channel and the second channel from the electrode. In some embodiments, the first channel, the second channel, and the third channel each include an inlet and an outlet, wherein the first opening is closer than the blocking plate to the inlets, and the blocking plate is closer than the second opening to the inlets. In some embodiments, the blocking plate is integrally formed with the second wall.

In some embodiments, the flow field further includes a bend joining the blocking plate and the second wall, wherein the second opening is adjacent the bend and is substantially the same size and shape as the blocking plate. In some embodiments, the first channel and the second channel are two of a first plurality of channels on the first side of the sheet, and the third channel is one of a second plurality of channels on the second side of the sheet. In some embodiments, the first opening and the second opening are two of a first plurality of openings in walls between each channel of the first plurality of channels and an adjacent channel in the second plurality of channels, and the blocking plate is one of a plurality of blocking plates, each blocking plate positioned across one of the first or second pluralities of channels and between adjacent openings.

In another aspect, the present disclosure describes a method of manufacturing a flow field for an electrochemical cell. The method includes bending a sheet into a bent condition in which the sheet forms a plurality of wave-shaped corrugations, the corrugations defining a first channel on a first side of the sheet, a second channel on the first side of the sheet, and a third channel between the first channel and the second channel on a second side of the sheet opposite the first side. The method further includes forming a first opening in the sheet, the first opening extending through a first wall separating the first channel and the third channel when the sheet is in the bent condition, forming a second opening in the sheet, the second opening extending through a second wall separating the first channel and the third channel when the sheet is in the bent condition, and positioning a blocking plate across the third channel between the first opening and the second opening.

In some embodiments, forming the second opening and positioning the blocking plate across the sheet includes cutting a partial outline of the second opening to form a tab, and bending the tab to form the second opening and the blocking plate. In some embodiments, the partial outline is cut before the sheet is bent. In some embodiments, the first opening and the second opening are cut before the sheet is bent. In some embodiments, the method further includes welding the blocking plate to the sheet.

The foregoing is a summary of the disclosure and thus by necessity contains simplifications, generalizations, and omissions of detail. Consequently, those skilled in the art will appreciate that the summary is illustrative only and is not intended to be in any way limiting. Other aspects, features, and advantages of the devices and/or processes described herein, as defined by the claims, will become apparent in the detailed description set forth herein and taken in conjunction with the accompanying drawings.

### BRIEF DESCRIPTION OF THE DRAWINGS

FIG. 1 is a side section view of a fuel cell stack, according to an exemplary embodiment.

FIG. 2 is a side section view of a fuel cell assembly with a traditional flow field along with an active reactant concentration graph.

FIG. 3A is a side section view of a fuel cell assembly according to an exemplary embodiment along with an active reactant concentration graph.

FIGS. 3B and 3C are top views of a fuel cell assembly having a configuration similar to that of FIG. 3A, according to two different exemplary embodiments.

FIGS. 4 and 5 are side section views of fuel cell assemblies according to exemplary embodiments.

FIG. 6A is a partial-section perspective view of a fuel cell assembly test setup, according to an exemplary embodiment.

FIG. 6B is an exploded view of the fuel cell assembly test setup of FIG. 6A.

FIG. 7A is a perspective view of a portion of a flow field, according to an exemplary embodiment.

FIGS. 7B and 7C are perspective detail views of the flow field of FIG. 7A.

FIG. 8 is a flow diagram of a method for manufacturing a flow field, according to an exemplary embodiment.

It will be recognized that the figures are schematic representations for purposes of illustration. The figures are provided for the purpose of illustrating one or more implementations with the explicit understanding that the figures will not be used to limit the scope of the meaning of the claims.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

According to an exemplary embodiment, a fuel cell flow field delays the introduction of a portion of the reactant gas until the portion flows past the reactant inlet of the electrode (e.g., the anode or the cathode). In some embodiments, a separator plate maintains separation between a portion of the reactant gas and the electrode until the reactant gas reaches an opening in or the end of the separator plate. The openings in or the length of the separator plate may be determined such that the chemical reactions in the fuel cell are spread more evenly across the cell and a more uniform temperature distribution is achieved. In some embodiments, the flow field may be designed such that the reactant gas immediately provided to the electrode (e.g., rather than being initially separated from the electrode and introduced later) flows to the other side of the separator plate before reaching the electrode outlet and is replaced by the separated reactant gas. While the flow fields are described herein as fuel cell flow fields, the flow fields may be used in fuel cells operated as electrolysis cells and in other types of electrochemical cells.

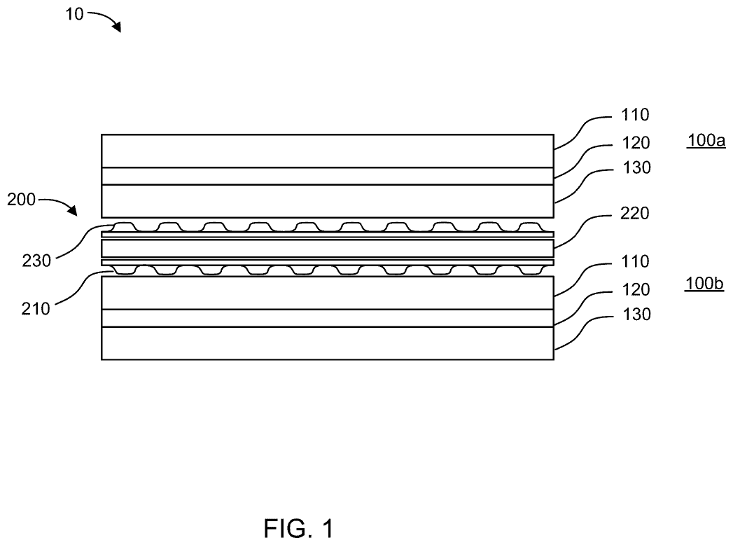

Referring to FIG. 1, a portion of a fuel cell stack 10 is shown, according to some embodiments. A first fuel cell 100a and a second fuel cell 100b are shown, each with an electrolyte 120 sandwiched between two electrodes (a cathode 110 and an anode 130). Between the two fuel cells is a separator assembly 200, which includes a bipolar plate 220 between a cathode flow field 210 and an anode flow field 230. Flow fields may also be referred to as flow field plates or current collectors. The flow fields 210, 230 may serve to distribute fuel and oxidant gases to the electrodes 110, 130 as well as to provide electrical connections between the fuel cells 100a, 100b. The anode flow field 230 may control the flow of fuel over the anode 130 of the first fuel cell 100a. Similarly, the cathode flow field 210 may control the flow of the oxidant over the cathode 110 of the second fuel cell 100b. The bipolar plate 220 may fluidly isolate the fuel flowing over the anode 130 of the first fuel cell 100a from the oxidant flowing over the cathode 110 of the second fuel cell 100b.

Flow fields may be used in molten carbonate fuel cell (MCFC) stacks, solid oxide fuel cell (SOFC) stacks, and other types of fuel cell stacks. A fuel cell stack may have several fuel cells 100 with a separator assembly 200 between each pair of adjacent fuel cells 100. In MCFCs, carbon dioxide and oxygen may be supplied to the cathode, and hydrogen may be supplied to the anode. Carbonate ions may form in the cathode and cross over the electrolyte to the anode, where they react with the hydrogen to form water and carbon dioxide. In SOECs, air may be supplied to the cathode, and hydrogen may be supplied to the anode. Oxide ions may form in the cathode and cross over the electrolyte to the anode, where they react with the hydrogen to form water.

Flow fields may also be used in electrolysis (e.g., electrolyzer) cell stacks, such as solid oxide electrolysis cell (SOEC) stacks and molten carbonate electrolysis cell (MCEC) stacks. In SOECs, steam may be supplied to and distributed by the cathode flow field, and an electrical current may be supplied to the cell to split water molecules into hydrogen gas, which remains on the cathode side, and oxide ions, which cross over the electrolyte to the anode side and form oxygen gas. In MCECs, steam and carbon dioxide are supplied to and distributed by the cathode flow field, and an electrical current may be supplied to the cell. Hydrogen gas may remain on the cathode side, while carbonate ions form in the cathode and cross over the electrolyte to the anode side, where they form carbon dioxide and oxygen.

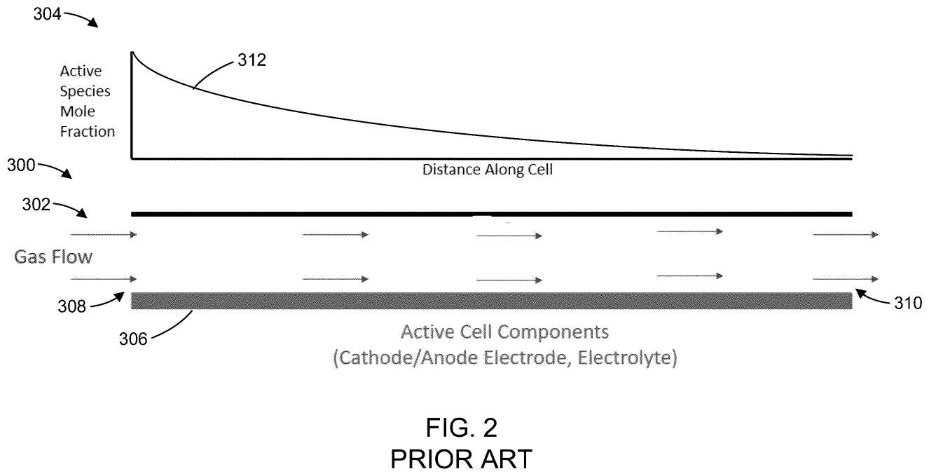

Referring to FIG. 2, a fuel cell assembly 300 with a traditional flow field 302 is shown along with an active reactant concentration graph 304 that illustrates the expected mole fraction of active species along the length of the cell (note that the graph does not reflect actual data or a simulation, but rather what one would generally expect from a flow field having this configuration). The fuel cell assembly 300 includes a fuel cell including an electrode 306 (e.g., an anode or a cathode) adjacent the flow field 302. The flow field 302 includes a reactant inlet 308 and a reactant outlet 310. Reactant gas flows into the flow field 302 from a reactant supply via the reactant inlet 308. The flow field 302 does not include a separator plate, so all of the reactant gas is exposed to the electrode 306 immediately upon entering near the reactant inlet 308. As a result, a significant amount of the reactant gas undergoes a chemical reaction near the reactant inlet 308. For example, in a case where the electrode 306 is an anode of an MCFC and the reactant gas is hydrogen, the hydrogen gas may react with carbonate ions at the anode, which results in the formation of carbon dioxide and steam. The unreacted hydrogen gas mixes with the carbon dioxide and steam as it travels along the length of the anode.

The active reactant concentration graph 304 shows the expected concentration of active reactant in the mixture of gases in the flow field 302 (e.g., the concentration of hydrogen in the mixture of hydrogen, carbon dioxide, and steam). As shown in the graph 304, the concentration of active reactant, illustrated by the curve 312, would be expected to decrease quickly after the reactant inlet 308, where a significant amount of reactions take place. As the active reactant mixes with the reaction products (e.g., as the hydrogen mixes with the carbon dioxide and steam) and continues to flow along the length of the electrode 306 toward the outlet 310, the concentration of active reactant would be expected to continue to decrease. Accordingly, the reaction of the active reactant may be concentrated near the reactant inlet 308 and may decrease along the length of the electrode 306 to the reactant outlet 310. Spent or depleted reactant, which may be diluted by the products of the reactions occurring at the electrode 306, is expelled from the fuel cell assembly 300 via the outlet 310.

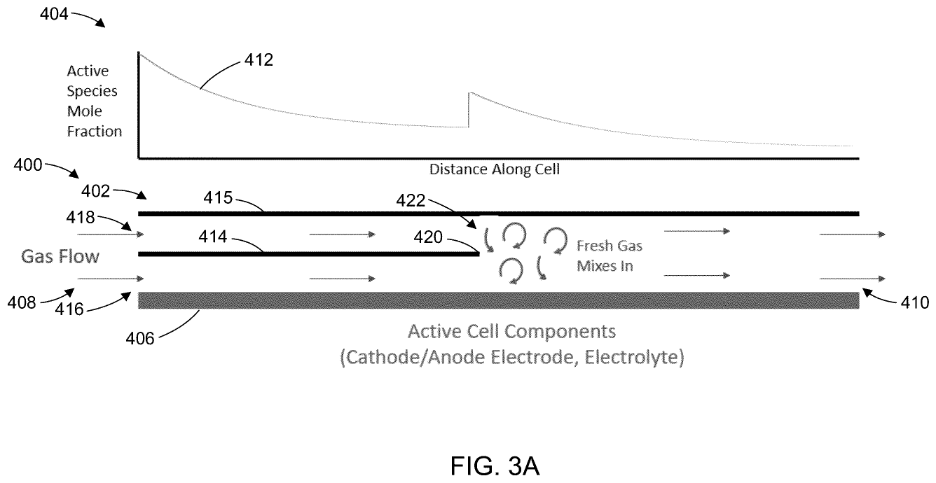

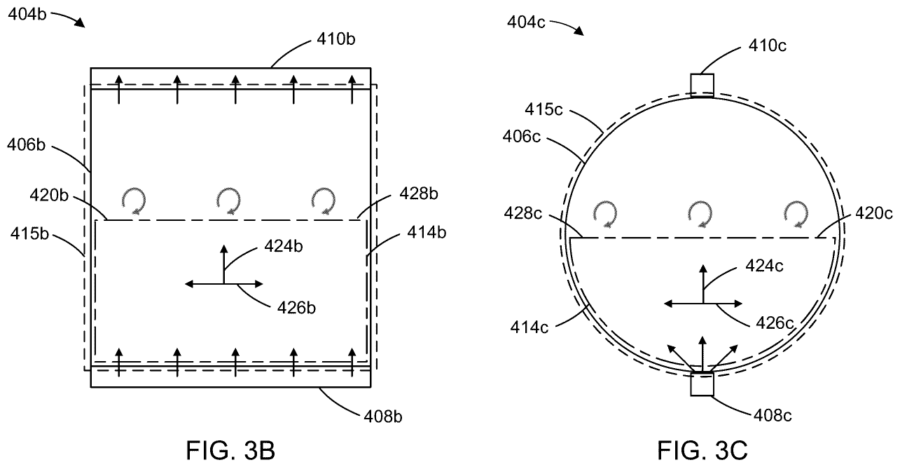

Referring to FIG. 3A, a fuel cell assembly 400 including a flow field 402 according to some embodiments is shown along with an active reactant concentration graph 404 (again, note that the graph does not reflect actual data or a simulation, but rather what one would generally expect from a flow field having this configuration). The fuel cell 400 includes a fuel cell including an electrode 406 (e.g., an anode or a cathode) adjacent the flow field 402. The flow field 402 includes a reactant inlet 408 and a reactant outlet 410. The flow field 402 further includes a separator plate 414 that divides the reactant gas a first portion of the reactant gas and a second portion of the reactant gas. The first portion of the reactant gas flows through a first flow channel 416 between the separator plate 414 and the electrode 406, such that the first portion of the reactant gas is immediately exposed to the electrode 406. The first portion of the reactant gas undergoes chemical reactions and is at least partially consumed, and in some cases may be diluted, by the product of the reactions. For example, in a solid oxide fuel cell, hydrogen may be supplied to the anode, and some of the hydrogen may be consumed in a chemical reaction with oxide ions to form steam, which dilutes the unreacted hydrogen. Oxygen may be supplied to the cathode, some of which may be reduced to oxide ions that are consumed in the steam-forming reaction at the anode. As the oxygen is consumed, the pressure of the remaining reactant may decrease. The remaining, unreacted oxygen may also be diluted by inert gases in the reactant stream, such as nitrogen.

The second portion of the reactant gas flows through a second flow channel 418 that is separated from the electrode 406 by the separator plate 414 and flows between another plate 415 (e.g., a first plate, a bipolar plate) and the separator plate 414. The separator plate 414 may extend from the reactant inlet 408 to a location between the reactant inlet 408 and the reactant outlet 410. In some embodiments, the separator plate 414 may extend to approximately halfway between the reactant inlet 408 and the reactant outlet 410, while in other embodiments, the separator plate 414 may be longer or shorter. The end 420 of the separator plate 414 defines a separator outlet 422 of the second flow channel 418. As the second portion of the reactant gas flows out of the separator outlet 422, the fresh reactant gas in the second portion of the reactant gas mixes with the diluted reactant in the first portion of the reactant gas, resulting in a combined reactant stream near the separator outlet 422 with a higher concentration of reactant than the first portion and a lower concentration of reactant than the second portion. At the separator outlet 422, the active reactant concentration increases as the fresh reactant gas mixes with the diluted reactant gas. Thus, the concentration of reactant that can come in contact with the electrode 406 increases along with the reactions occurring at the electrode 406.

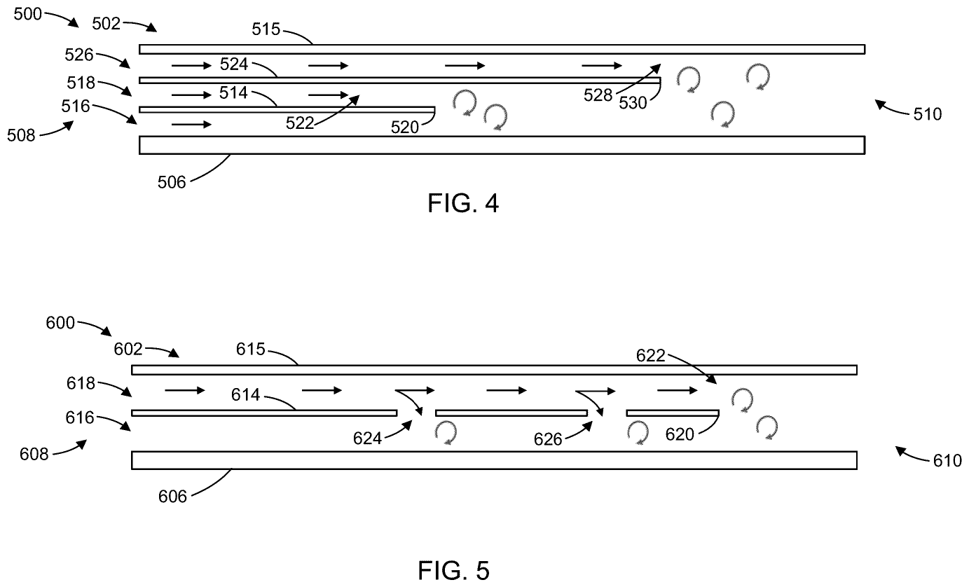

The curve 412 of the graph 404 shows the expected active reactant concentration of the gas that is not separated from the electrode 406. Specifically, the curve 412 shows the active reactant concentration in the first portion of the reactant gas between the reactant inlet 408 and the separator outlet 422 and the active reactant concentration of the combined reactant stream between the separator outlet 422 and the reactant outlet 410. The curve 412 shows that the reactant concentration would be expected to decrease as the gases flow from the reactant inlet 408 toward the separator outlet 422, nearly immediately increases at the separator outlet 422, and then decreases from the separator outlet 422 to the reactant outlet 410. As discussed above, the reactant concentration in contact with the electrode substantially corresponds to the amount of reaction occurring at the electrode 406. Thus, rather than a single high-reaction area near the reactant inlet 408, as shown in the active reactant concentration graph 304 of FIG. 2, the flow field 402 causes a second high-reaction area near the separator outlet 422. As a consequence, the heat generated by the exothermic reactions in the electrode 406 is more evenly distributed along the electrode 406 in the fuel cell assembly 400 than in the fuel cell assembly 300. FIGS. 4 and 5 show additional embodiments in which the reactions may be even more evenly distributed by including additional flow channels and/or openings in the flow channels.

FIGS. 3B and 3C illustrate top views of two different configurations for a fuel cell assembly having the general configuration of fuel cell assembly 400, with similar reference numerals used to describe similar parts. The fuel cell assembly 400b of FIG. 3B includes a fuel cell with a rectangular electrode 406b, while the fuel cell assembly 400c of FIG. 3C includes a fuel cell with a circular electrode 406c. According to other embodiments, the fuel cells and their corresponding electrodes may have any desired shape when viewed from above, including an annular shape.

As shown in FIGS. 3B and 3C, the first plate 415b/415c, which may be a bipolar plate, may span or cover substantially the entire footprint of the electrode 406b/406c. Thus, the first plate 415b/415c may have substantially the same shape and surface area as the associated electrode 406b/406c. As used herein, “span” or “cover” refers to a plate (e.g., plates 414b/414c, 415b/415c) being positioned, for example, above or below an electrode such that the plate blocks from view at least a portion of the electrode when viewed from above or below, respectively. Thus, the first plate 415b/415c, when positioned above the electrode 406b/406c, may substantially completely block the electrode 406b/406c from view when viewed from above. It should be understood that the first plate 415b/415c is shown as slightly larger than the associated electrode 406b/406c such that the lines outlining the first plate 415b/415c are visible, but the first plate 415b/415c may have substantially the same footprint as the associated electrode 406b/406c. The reactant inlet 408b of the fuel cell assembly 400b of FIG. 3B is shown as an inlet channel that supplies reactant across the entire width of the electrode 406b. The reactant outlet 410b of the fuel cell assembly 400b of FIG. 3B is shown as an outlet channel that receives spent reactant (e.g., unreacted reactant, a mixture of reaction products and unreacted reactant, etc.) across the entire width of the electrode 406b. The reactant inlet 408c of the fuel cell assembly 400c of FIG. 3C is shown as an inlet opening that supplies reactant via a small opening to one location at the edge of the electrode 406c. The reactant outlet 410c of the fuel cell assembly 400c of FIG. 3C is shown as an outlet opening that receives spent reactant via a small opening at one location at the edge of the electrode 406c. In each case, reactant may travel in a prevailing direction, defined as the flow direction 424b/424c, from the reactant inlet 408b/408c to the reactant outlet 410b/410c, though portions of the reactant may locally flow in various directions due to pressure differences and turbulence. A direction perpendicular to the flow direction 424b/424c may be defined as a width direction 426b/426c.

The separator plate 414b/414c may be positioned adjacent the reactant inlet 408b/408c and may extend in the flow direction 424b/424c to a first position 428b/428c at the end 420b/420c of the separator plate 414b/414c. The first position 428b/428c may be between the inlet 408b/408c and the outlet 410b/410c and may be a line or curve extending across the electrode 406b/406c, substantially in the width direction 426b/426c. The separator plate 414b/414c may span or cover less than the entire footprint of the electrode but substantially the entire footprint of the portion of the electrode 406b/406c between the inlet 408b/408c and the first position 428b/428c. Thus, the separator plate 414b/414c may have substantially the same shape and surface area as the portion of the electrode 406b/406c between the inlet 408b/408c and the first position 428b/428c. The width of the separator plate 414b/414c in the width direction 426b/426c at a given position along the flow direction 424b/424c may be substantially the same as the width of the electrode 406b/406c at in the width direction 426b/426c at the same position along the flow direction 424b/424c. It should be understood that the separator plate 414b/414c is shown as slightly smaller than the portion of the electrode 406b/406c between the inlet 408b/408c and the first position 428b/428c, such that the lines outlining the first plate 415b/415c are visible, but the first plate 415b/415c may have substantially the same footprint as the portion of the electrode 406b/406c between the inlet 408b/408c and the first position 428b/428c. The first position may be, for example, between 30% and 70% of the distance from the inlet 408b/408c to the outlet 410b/410c, or between 40% and 60% of the distance from the inlet 408b/408c to the outlet 410b/410c, or between 45% and 55% of the distance from the inlet 408b/408c to the outlet 410b/410c, or at approximately half the distance between the inlet 408b/408c to the outlet 410b/410c. However, the first position may be at any position between the inlet 408b/408c and the outlet 410b/410c. Between the first position 428b/428c and the outlet 410b/410c, the separator plate 414b/414c may not separate the first portion of the reactant from the second portion of the reactant, and the first and second portions may be allowed to mix.

Referring now to FIG. 4, a fuel cell assembly 500 including a flow field 502 is shown, according to an exemplary embodiment. The flow field 502 is substantially similar to the flow field 402, except that the flow field 502 includes a second separator plate 524 defining a third flow channel 526. The second separator plate 524 is configured to divide the second portion of the reactant, as described above, into a third portion of the reactant between the first separator plate 514 and the second separator plate 524 and a fourth portion of the reactant between the second separator plate 524 and the first plate 515. Said another way, the first separator plate 514 and the second separator plate 524 may cooperatively divide the reactant into a first portion of the reactant between the first separator plate 514 and the electrode 506, a second portion of the reactant between the first separator plate 514 and the second separator plate 524, and a third portion of the reactant between the second separator plate 524 and the first plate 515. The fuel cell assembly 500 includes a fuel cell including an electrode 506 (e.g., an anode, a cathode) and the flow field 502. The flow field 502 includes the first separator plate 514 and the second separator plate 524, which define a first flow channel 516 between the electrode 506 and the first separator plate 514, a second flow channel 518 between the first separator plate 514 and the second separator plate 524, and the third flow channel 526 between the second separator plate 524 and the first plate 515 (e.g., a bipolar plate). Reactant gas flows in through a reactant inlet 508 where a first portion enters the first flow channel 516, a second portion enters the second flow channel 518, and a third portion enters the third flow channel 526. The first portion of reactant gas may be immediately exposed to the electrode 506 and may undergo chemical reactions and be diluted by the product of the reactions or consumed as it flows along the electrode 506. The second portion of the reactant may travel through the second flow channel 518, separated from the anode by the first separator plate 514 until it reaches a first separator outlet 522 defined by the end 520 of the separator plate 514 at a first position. At the first separator outlet 522, the fresh reactant in the second portion of reactant may mix with the diluted or partially consumed first portion of reactant to form a first combined reactant stream, thus increasing the concentration of active reactant exposed to the electrode 506. As in the flow field 402 of FIG. 3A, the amount of reaction may immediately increase near the first separator outlet 522. The concentration of active reactant, as well as the amount of reaction, may then decrease as the first combined reactant stream flows along the electrode 506, undergoes chemical reactions, and is diluted by the product of the reactions or inert gases in the reactant stream.

The third portion of the reactant travels through the third flow channel 526, separated from the electrode 506 by the second separator plate 524 until it reaches a second separator outlet 528 defined by the end 530 of the separator plate 514 at a second position. The second position may be closer than the first position to the outlet 510. At the second separator outlet 528, the fresh reactant in the third portion of reactant mixes with the diluted first combined reactant stream to form a second combined reactant stream, thus increasing the concentration of active reactant exposed to the electrode 506. The amount of reaction may immediately increase near the second separator outlet 528. The concentration of active reactant, as well as the amount of reaction, may then decrease as the second combined reactant stream flows along the electrode 506 toward the reactant outlet 510, undergoes chemical reactions, and is diluted by the product of the reactions or inert gases in the reactant stream. Though not shown, a graph of the active species mole fraction along the length of the fuel cell assembly 500 would be expected to be similar to the graph 404, except that a second sharp increase in active species mole fraction would present proximate the second separator outlet 528, although the second increase would be smaller than the first due to the increased volume of diluents along the length of the fuel cell assembly 500. Between the first separator outlet 522 and the second separator outlet, the active species mole fraction would decrease, as the active species are consumed in the fuel cell reactions and diluted. Because fresh fuel remains separated from the electrode 506 until it reaches the separator outlets 522, 528, the concentration of active reactant exposed to the electrode 506 may be increased at the separator outlets 522, 528. Thus, the heat generated may be spread throughout the electrode 506, with heat concentrations near the separator outlets 522, 528 and the reactant inlet 508, unlike in the traditional flow field 302 of FIG. 2, where the reactions and corresponding heat generation are concentrated only near the reactant inlet 308. In some embodiments, the fuel cell assembly 500 may include additional separator plates of varying lengths (e.g., with outlets at different locations) to further distribute fresh reactant across the electrode 506 and provide a more even heat distribution throughout the cell. Reducing heat concentrations and temperature differences across the cell may improve the lifetime of the fuel cell assembly 500.

Referring now to FIG. 5, a fuel cell assembly 600 including a flow field 602 is shown according to another exemplary embodiment. The flow field 602 is substantially similar to the flow field 402, except that the separator plate 614 includes additional outlet openings 624, 626 in addition to the separator outlet 622, which may also be defined as an opening. In some embodiments, the fuel cell assembly 600 may not include the separator outlet 622. The fuel cell assembly 600 includes a fuel cell including an electrode 606 (e.g., an anode, a cathode) and the flow field 602. The flow field 602 includes a separator plate 614, which defines a first flow channel 616 between the electrode 606 and the first separator plate 614 and a second flow channel 618 between the separator plate 614 and a second plate 615 (e.g., a bipolar plate). Reactant gas flows in through a reactant inlet 608 where a first portion enters the first flow channel 616 and a second portion enters the second flow channel 618. The first portion of reactant gas is immediately exposed to the electrode 606 and may undergo chemical reactions and be diluted by the product of the reactions as it flows along the electrode 606. The second portion of the reactant travels through the second flow channel 618, separated from the electrode 606 by the first separator plate 614 until it reaches a first opening 624. A first fraction of the second portion of the reactant in the second flow channel 618 flows through the first opening 624 and mix with the diluted first portion of reactant in the first flow channel 616 to form a first combined reactant stream. The remainder of the second portion continues to flow through the second flow channel 618 toward the second opening 626. A second fraction of the second portion of the reactant in the second flow channel 618 flows through the first opening 624 and mixes with the diluted first combined reactant stream in the first flow channel 616 to form a second combined reactant stream. The remainder of the second portion continues to flow through the second flow channel 618 toward the separator outlet 622, defined by the end 620 of the separator plate 614, where it mixes with the diluted second combined reactant stream.

Thus, at each of the first opening 624, the second opening 626, and the separator outlet 622, fresh reactant is exposed to the electrode 606, increasing the active reactant concentration of the gas exposed to the electrode 606 and the corresponding reactions. By adding the openings 624, 626, the locations at which fresh reactant is introduced to the electrode 606 are increased, and the heat generated by the reactions at the electrode 606 can be spread across the fuel cell. As discussed above, reducing heat concentrations and temperature differences across the cell may improve the lifetime of the fuel cell assembly 600. In some embodiments, the fuel cell assembly 600 may include multiple separator plates, as in the fuel cell assembly 500, some or all of which may include openings 624, 626. For example, referring again to FIG. 4, the first separator plate 514 may include openings similar to openings 624, 626, which allow a portion of the second portion of the reactant to flow through to the electrode 506. However, depending on the relative pressure of the first and second portions of the reactant, some of the first portion of the reactant may also flow up through the opening into the second flow channel 518. Thus, the second portion of the reactant may be partially diluted downstream of the openings. The second separator plate 524 may not include openings, such that the third portion of the reactant remains undiluted until it exits the third flow channel 526. A flow field according to an embodiment of the present disclosure may include any number of separator plates and openings in order to more evenly distribute active reactant such that the exothermic reactions at the electrode are spread across the surface area of the electrode. Though not shown, a graph of the active species mole fraction along the length of the fuel cell assembly 500 would be expected to show increases in the active species mole fraction in locations proximate the openings 624, 626 and the separator outlet 622, with the active species mole fraction decreasing between the openings 624, 626 and between the second opening 626 and the separator outlet 622 as the active species are consumed in the fuel cell reactions and diluted.

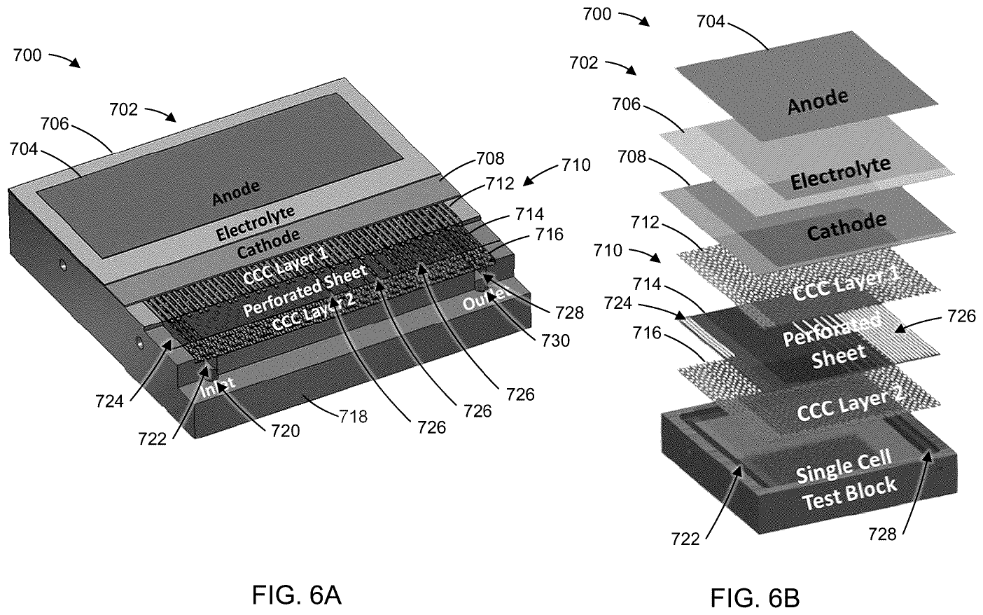

Referring now to FIGS. 6A and 6B, a partial-section perspective view and a perspective exploded view of a fuel cell assembly test setup 700 are respectively shown, according to some embodiments. The fuel cell assembly includes a fuel cell 702 including an anode 704 and a cathode 708 separated by an electrolyte 706. The fuel cell assembly test setup 700 further includes a flow field assembly 710 including a first current collector layer 712 and a second current collector layer 716 separated by a perforated sheet 714. The second current collector layer 716 is shown positioned adjacent a reactant distribution test block 718. Reactant flows into the test block 718 via an inlet 720 and through an inlet channel 722. The perforated sheet 714 includes a first group of openings 724 directly above the inlet channel 722 that allow reactant to flow therethrough and be exposed to the cathode 708 near the inlet channel 722. The remainder of the reactant is trapped between the perforated sheet 714 and the test block 718 and flows toward an outlet channel 728 without immediately being exposed to the cathode 708. Thus, the perforated sheet 714 is similar to the separator plates 414, 514, 614 by dividing the flow of reactant between the first current collector layer 712, where the reactant is exposed to the cathode 708, and the second current collector layer 716, where the reactant is not exposed to the cathode 708. The perforated sheet 714 includes additional openings 726 (e.g., similar to the openings 624, 626) distributed along the length of the flow field assembly 710. Reactant may flow through the openings, mixing with the reactant already exposed to the cathode 708 and the product of the reactions, thus increasing the concentration of active reactant at each opening 726. The perforated sheet 714 thus spreads the fresh reactant, as well as the heat caused by the reactions, across the surface area of the cathode 708. As the reaction products and any unreacted reactant reach the outlet side of the fuel cell 702, the gases flow through the openings 726 back to the other side of the perforated sheet 714, into the outlet channel 728 and out of the outlet 730. The distribution of openings 726 (e.g., the number of openings and the spaces between the openings) can be designed to optimize the heat distribution across the fuel cell 702. For example, the openings 726 closest to the inlet channel 722 may be spaced farther apart than the openings closer to the outlet channel 728. In a separator plate or perforated sheet with three openings, for example, the two openings closest to the inlet may be farther apart than the two openings closest to the outlet. Thus, the concentration of openings 726 may increase as the concentration of reaction products increases.

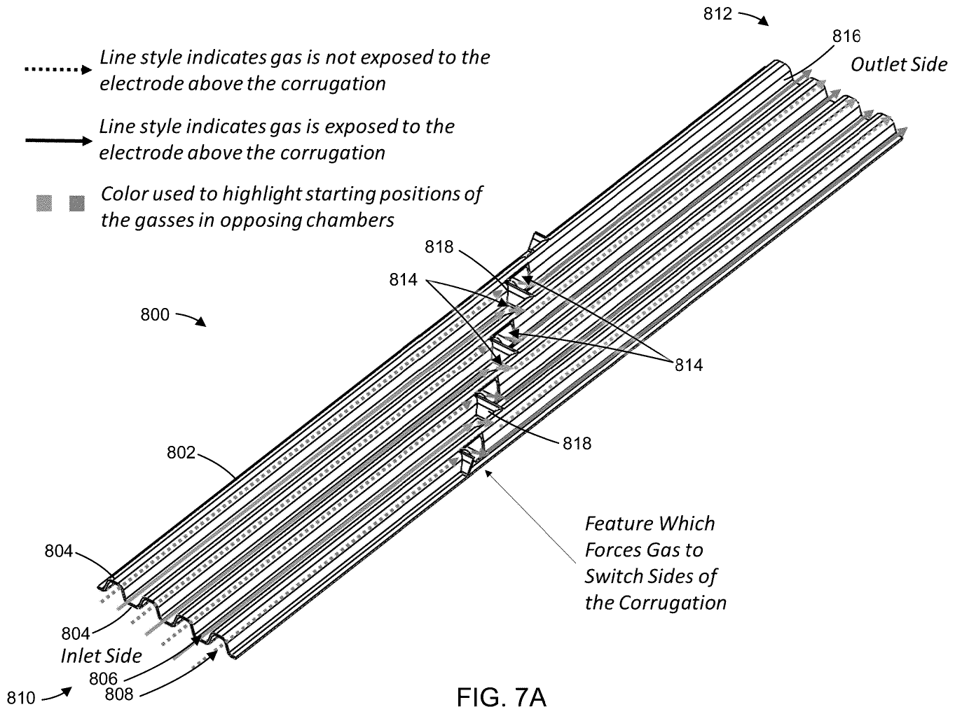

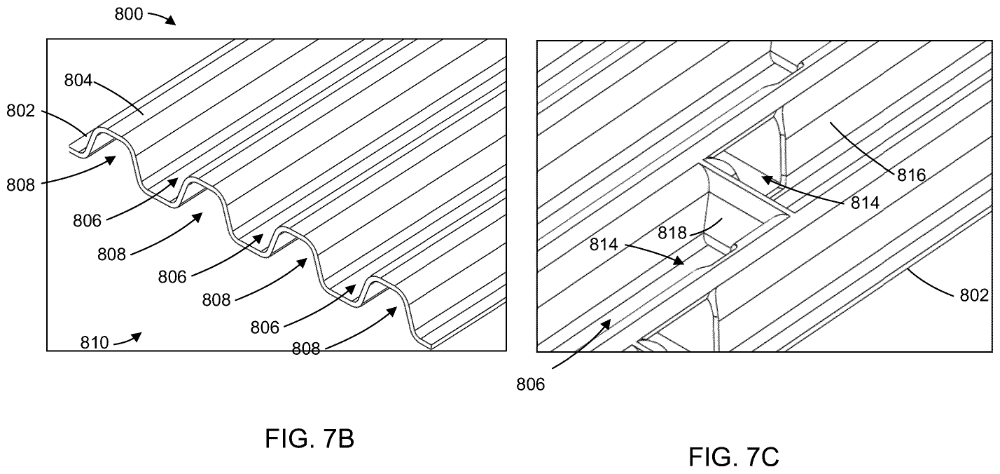

Referring now to FIG. 7A-7C, perspective views of a portion of a flow field 800 is shown, according to some embodiments. The flow field 800 may be formed from a plate 802 (e.g., sheet) that is formed (e.g., bent) into a plurality of wave-shaped corrugations 804 defining first channels 806 and second channels 808, which are shown in FIG. 7A as upper channels 806 and lower channel 808. The flow field 800 may be positioned below (as shown in FIG. 7A) an electrode of a fuel cell, as discussed above. In some embodiments, the corrugations 804 may be V-shaped (e.g., triangle-shaped) or another shape in which channels are formed on alternating sides of the plate 802. In addition to forming channels, the corrugations 804 may provide compressive spring force when arranged in a fuel cell stack. Reactant gas is supplied to the flow field 800 via the inlet side 810 and flows above the plate 802 into the upper channels 806 and below the plate 802 into the lower channels 808. The inlet side 810 is shown in further detail in FIG. 7B. Though not shown, a second plate (e.g., a bipolar plate) similar to the plates 415, 515, 625 may be positioned adjacent the flow field 800 on the opposite side of the fuel cell (e.g., below the flow field 800 as the flow field 800 is shown in FIG. 7A) to contain the reactant in the lower channels 808. The reactant in the upper channels 806 is immediately exposed to the electrode, while the reactant in the lower channels 808 remains separated from the electrode by the plate 802. The reactant in the upper channels 806 reacts in the presence of the electrode and may become diluted by the product of the reactions as the reactant flows through the upper channels 806 toward the outlet side 812 of the flow field 800. In between the inlet side 810 and the outlet side 812, the plate 802 may include openings 814 in the walls 816 separating the upper channels 806 and the lower channels 808. These openings 814 allow reactant in the lower channels 808 to flow into the upper channels 806 and diluted reactant in the upper channels 806 to flow into the lower channels 808. It should be understood that the openings 814 through which diluted reactant flows from the upper channels 806 into the lower channels 808 are not visible in FIG. 7A due to the perspective of the figure. The lines in FIG. 7A running along the channels 806, 808 show the flow of reactant, with solid lines indicating reactant in the upper channels 806 and dotted lines showing the flow of reactant in the lower channels 808. In some embodiments, reforming catalyst (e.g., catalyst pellets) may be stored in the channels 806, 808, for example, in the lower channels 808 before the reactant is exposed to the electrolyte. The reforming catalyst may cause methane in the reactant stream (e.g., in the fuel stream provided to the anode) to react with steam to form hydrogen. The channels 806, 808 may continue beyond the edge of the electrode and continue to reform methane to mitigate emissions. The channels 806, 808 may also store electrolyte material, which may diffuse through the adjacent electrode to the fuel cell electrolyte during the first few months of operation of the fuel cell to replenish the fuel cell electrolyte. In some embodiments of a MCFC stack, catalyst may be stored in the channels 806, 808 on the anode side of each fuel cells, and electrolyte may be stored in the channels 806, 808 on the cathode side of each fuel cell.

As shown in FIGS. 7A and 7C, the flow field 800 includes blocking plates 818 that block the flow of reactant or diluted reactant from continuing along the respective channel 808, 806, directing the reactant or diluted reactant through the openings 814. The blocking plates 818 and openings 814 are shown in further detail in FIG. 7C. Thus, as the reactant in a first upper channel 806 becomes diluted, it is directed through a first opening 814 by a first blocking plate 818 into a first adjacent lower channel 808 (e.g., to the right of the first upper channel 806 as shown). Fresh reactant in a second adjacent lower channel 808 (e.g., to the left of the first upper channel 806 as shown) is directed through a second opening 814 into the first upper channel 806. The second opening 814 is positioned just behind the first blocking plate 818 in the flow direction, such that fresh fuel is supplied to the first upper channel 806 immediately after the diluted fuel is removed. Thus, when the flow field 800 is positioned between an electrode and a second plate (e.g., a bipolar plate), the first blocking plate 818 may fluidly isolate the first opening 814 from the second opening 814, such that the diluted fuel in the first upper channel 806 does not mix with the fresh fuel in the second lower channel 808. The openings 814 may be staggered as shown in FIG. 7A such that fresh fuel from the lower channels 808 does not mix with the diluted fuel in the upper channels 806. Instead, diluted fuel is fully removed from the upper channels 806, and fresh fuel from the lower channels 808 replaces the diluted fuel for the remainder of the length of the plate 802. The diluted fuel in the upper channels 806 is moved to the lower channel 808 and is not exposed to the electrode for the remainder of the length of the plate. The blocking plates 818 ensure that substantially none of the diluted fuel can mix with the fresh fuel. The flow field 800 may increase reactant utilization by completely removing the diluted reactant via the openings rather than allowing the fresh reactant to mix with the diluted reactant. The fresh fuel supplied via the openings 814 then reacts and is itself diluted by the products of reaction as it travels along the upper channels 806. Diluted fuel is then output from both the upper channels 806 and the lower channels 808 at the outlet side 812 of the plate 802.

In some embodiments, flue gas containing sulfur may be provided to a cathode of a molten carbonate fuel cell for carbon capture. The sulfur may cross over the electrolyte near the cathode inlet to the anode and may deposit on reforming catalyst stored on the anode side, inhibiting the catalyst activity and the reforming of methane. In a co-flow configuration, the anode inlet and cathode inlet may be positioned on the same side of the fuel cell. To reduce the amount of sulfur accumulating on the catalyst, the blocking plates 818 on the anode side may be positioned relatively close to the anode inlet, so that the sulfur is swept to the lower channels 808, separated from the anode, before it can accumulate on downstream catalyst in the upper channels 806.

As discussed above with respect to FIGS. 3-6B, providing fresh fuel to the electrode in locations other than the primary fuel inlet may help to distribute the reactions across the surface area of the electrode and reduce heat concentrations caused by exothermic chemical reactions. In addition to stopping the mixing of diluted fuel with fresh fuel, the staggered arrangement of the openings 814 may further improve the heat distribution compared to an embodiment in which fresh reactant is supplied to a larger section of the electrode at the same distance from the inlet. For example, as shown in FIG. 7, the rightmost upper channel 806 receives fresh reactant from the adjacent lower channel 808 relatively close to the inlet side 810, the next upper channel 806 receives fresh fuel farther along the length of the channel 806, and so on. In this arrangement, the heat concentrations, near the openings 814, are staggered and more spaced out compared to an embodiment in which fresh fuel is supplied at the same distance from the inlet side 810 which may result in a line of heat concentration stretching across the plate 802 perpendicular to the flow direction.

The blocking plates 818 may be integrally formed with the plate 802. For example, the blocking plates 818 may be portions of the side walls 816 of the channels 806, 808. A partial outline of the opening 814 may be cut (e.g., three sides of a rectangular opening) to form a tab that may be bent to form both the opening 814 and the blocking plate 818. Thus, a bend (e.g., a bent portion of the plate 802) may couple the blocking plate 818 to the side wall 816, and the opening 814 formed may be adjacent the bend and substantially the same shape and size as the blocking plate 818. In some embodiments, the lower and distal sides of the blocking plates 818 may be welded to the side wall 816 of the adjacent channel 806, 808. In some embodiments, the cuts to form the blocking plates 818 may be formed in a flat sheet, which may be made of metal (e.g., stainless steel), the flat sheet may be bent to form the corrugations 804, and then the blocking plates 818 may be bent away from the side walls 816 and, in some embodiments, welded to the adjacent side walls 816. In some embodiments, the cuts to form the blocking plates 818 may be made after the flat sheet is bent to form the corrugations 804. In some embodiments, the blocking plates 818 may not be welded but may still block substantially all of the diluted reactant from mixing with the fresh reactant. For example, compressive forces on the fuel cell stack may maintain sufficient sealing between the blocking plates 818 and the channels 806, 808 without welding. In some embodiments, the blocking plates 818 may not be integrally formed with the plate 802 and may be separate components that may be welded to the plate. In such an embodiment, the openings 814 may be formed before or after a flat sheet is bent to form the corrugations 804. In some embodiments, the blocking plates 818 may be made from the material removed to form the openings 814. For example, an entire outline of an opening may be cut, and the material removed from the sheet 802 may be welded to the sheet 802 to form the blocking plate 818.

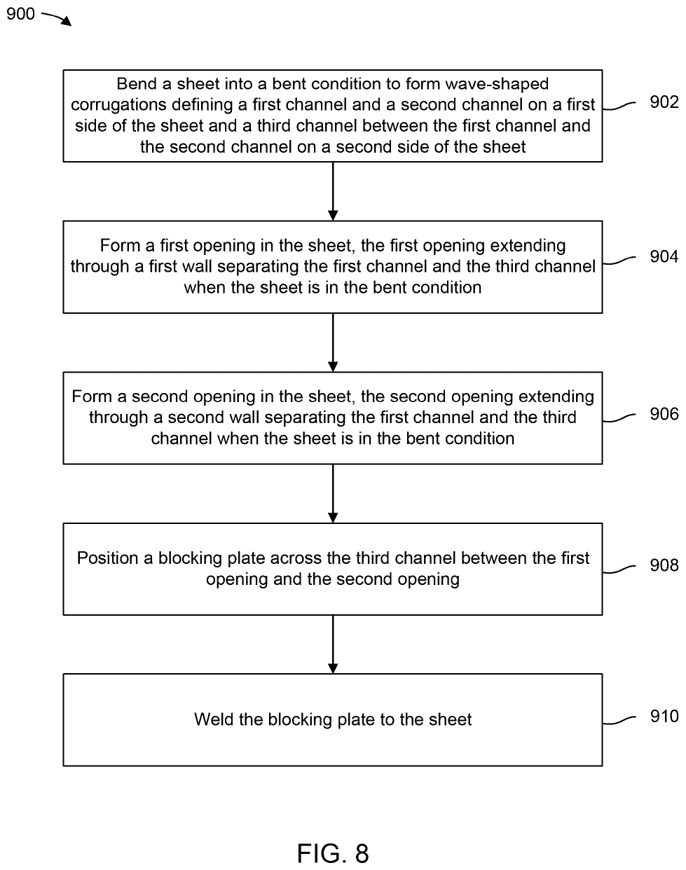

Referring now to FIG. 8, a method 900 for manufacturing a flow field (e.g., flow field 800) is shown, according to some embodiments. In operation 902 of the method 900, a sheet (e.g., a flat sheet, sheet 802, etc.) is bent into a bent condition to form wave-shaped corrugations. The wave-shaped corrugations define a first channel and a second channel (e.g., channels 808) on a first side of the sheet and a third channel (e.g., channel 806) on a second side of the sheet opposite the first side. At operation 904 of the method 900, a first opening (e.g., opening 814) is formed in the sheet, and at operation 906 of the method 900, a second opening is formed in the sheet. When the sheet is in the bent condition, the first opening extends through a wall (e.g., the wall 816) separating the first channel and the third channel, and the second opening extends through a wall separating the second channel and the third channel. As discussed above, the openings may be formed before or after the sheet is bent in operation 902. At operation 908 of the method 900, a blocking plate (e.g., blocking plate 818) is positioned across the third channel between the first opening and the second opening. In some embodiments, forming the second opening and positioning the blocking plate across the third channel may include cutting a partial outline of the second opening to form a tab and bending the tab to form the second opening and the blocking plate, the blocking plate coupled to the wall of the channel by a bend. In some embodiments, the partial outline may be cut to form the tab before the sheet is bent in operation 902. In some embodiments, the blocking plate may be a separate component. In some embodiments, an entire outline of an opening may be cut, and the material removed from the sheet may be used as the blocking plate. In some embodiments, the method 900 may include operation 910. At operation 910, the blocking plate is welded to the sheet. For example, if the blocking plate is formed by bending the tab as described above, the blocking plate may be welded to the bottom (or top, depending on the orientation of the sheet) of the adjacent channel and/or the wall of the channel opposite the bend. If the blocking plate is not integrally formed with the sheet, the blocking plate may be welded to the bottom and each wall of the third channel.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the Figures. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention. For example, the heat recovery heat exchangers may be further optimized.

What is claimed is:

1. A flow field for supplying a reactant to an electrode of an electrochemical cell, the flow field comprising:
an inlet configured to receive the reactant from a reactant supply;
an outlet configured to expel spent reactant, the outlet positioned on an opposite side of the flow field from the inlet;
a first plate configured to contain the reactant between the first plate and the electrode across substantially an entire surface area of the electrode; and
a separator plate configured to be positioned between the first plate and the electrode and to divide the reactant into a first portion and a second portion at the inlet, the separator plate having a smaller surface area than the first plate.

2. The flow field of claim 1, wherein the separator plate is configured to separate the second portion of the reactant from a portion of the electrode.

3. The flow field of claim 2, wherein the separator plate extends from the inlet to a first position between the inlet and the outlet.

4. The flow field of claim 3, wherein the separator plate has substantially the same surface area as and spans substantially an entire footprint of the surface area of a portion of the first plate defined between the inlet and the first position.

5. The flow field of claim 3, wherein between the first position and the outlet, the separator plate does not separate the first portion of the reactant from the second portion of the reactant.

6. The flow field of claim 3, further comprising a second separator plate configured to divide the second portion of the reactant into a third portion of the reactant between the separator plate and the second separator plate and a fourth portion of the reactant between the second separator plate and the first plate.

7. The flow field of claim 1, wherein the separator plate comprises an opening configured to allow the first portion of the reactant to mix with the second portion of the reactant.

8. The flow field of claim 1, wherein the separator plate comprises a plurality of openings configured to allow the first portion of the reactant to mix with the second portion of the reactant, wherein a space between the closest opening to the inlet and the second closest opening to the inlet is larger than a space between the second closest opening to the inlet and the third closest opening to the inlet.

9. The flow field of claim 8, wherein the space between adjacent openings decreases as the separator plate approaches the outlet.

10. An electrochemical cell assembly comprising:
an electrochemical cell comprising an electrode;
a flow field assembly positioned adjacent the electrode, the flow field assembly comprising:
a first plate spanning substantially an entire footprint of the electrode;
a separator plate positioned between the first plate and the electrode and spanning less than the entire footprint of the electrode, the separator plate defining a first flow channel between the separator plate and the electrode and a second flow channel between the separator plate and the first plate;
an inlet configured to receive reactant from a reactant supply and to supply the reactant to the first flow channel and the second flow channel; and
an outlet configured to expel spent reactant, the outlet positioned on an opposite side of the first plate from the inlet.

11. The electrochemical cell assembly of claim 10, wherein the separator plate has substantially the same surface area as and spans substantially an entire footprint of a portion of the electrode between the inlet and a first position along a flow direction, wherein the flow direction is defined as a prevailing direction of reactant flow from the inlet to the outlet.

12. The electrochemical cell assembly of claim 11, wherein the separator plate is configured to separate a portion of the reactant from the portion of the electrode between the inlet and the first position.

13. The electrochemical cell assembly of claim 11, wherein the second flow channel joins the first flow channel at the first position.

14. The electrochemical cell of claim 10, wherein the separator plate comprises an opening configured to allow a first portion of reactant in the first flow channel to mix with a second portion of reactant in the second flow channel.

15. The electrochemical cell assembly of claim 10, wherein the separator plate comprises a plurality of openings configured to allow a first portion of reactant in the first flow channel to mix with a second portion of reactant in the second flow channel, wherein a space between the closest opening to the inlet and the second closest opening to the inlet is larger than a space between the second closest opening to the inlet and the third closest opening to the inlet.

16. The electrochemical cell assembly of claim 15, wherein the space between adjacent openings decreases as the separator plate approaches the outlet.

17. An electrochemical cell assembly comprising:
an electrochemical cell comprising an electrode;
a flat plate;
a flow field positioned between the electrode and the plate, the flow field comprising:
a sheet comprising a plurality of wave-shaped corrugations, the wave-shaped corrugations forming a first channel between the plate and the sheet, a second channel between the plate and the sheet, and a third channel between the first channel and the second channel and between the sheet and the electrode;
a first opening in a first wall separating the first channel and the third channel;
a second opening in a second wall separating the second channel and the third channel; and
a blocking plate positioned across the third channel between the first opening and the second opening.

18. The electrochemical cell assembly of claim 17, wherein the blocking plate is configured to fluidly isolate the first opening from the second opening.

19. The electrochemical cell assembly of claim 17, wherein the third channel is exposed to the electrode, and the sheet blocks the first channel and the second channel from the electrode.

20. The electrochemical cell assembly of claim 17, wherein the first channel, the second channel, and the third channel each include an inlet and an outlet, wherein the first opening is closer than the blocking plate to the inlets, and the blocking plate is closer than the second opening to the inlets.
